(19) United States
(12) Patent Application Publication
(10) Pub. No.: US 2008/0084591 A1
(43) Pub. Date: Apr. 10, 2008

(54) IMAGING APPARATUS WITH MOVEABLE ENTRANCE GUIDE

(76) Inventors: Bradley B. Rassatt, Apple Valley, MN (US); Scott C. Milton, Maplewood, MN (US)

Correspondence Address: Carestream Health Inc,, 150 Verona Street, Rochester, NY, 14608, US

(21) Appl. No.: 11/538,920

(22) Filed: Oct. 5, 2006

(51) Int. Cl. H04N 1/04

(52) U.S. Cl. 358/498; 358/505

(57) ABSTRACT

An imaging apparatus includes an exposure system having an output engagement point and operating at a first rate, and a processor having an input engagement point and operating at a second rate, which is at least equal to the first rate. A guide assembly includes an entrance guide which is configured to be at an extended position and to introduce a curve to and to direct an imaging media along a curved first transport path having a first length between the output and input engagement points before a leading edge of the imaging media is engaged by the input engagement point, the first length being less than a transport direction length of the imaging media, and which is configured to move to a retracted position after the leading edge is engaged by the input engagement point but while a trailing length of the imaging media is still engaged by the output engagement point to enable the imaging media to transition to a second transport path having a second length which is less than the first length.

### FIELD OF THE INVENTION

The present invention relates generally to the field of imaging and in particular to an imaging apparatus having an exposure system and a processing system. More specifically, the invention relates to an imaging apparatus having a transport system employing a moveable entrance guide.

### BACKGROUND OF THE INVENTION

Light sensitive photothermographic film is used in many applications ranging from photocopying apparatus to medical imaging systems. For example, laser imagers are widely used in the medical imaging field to produce a visual representation on film of digital image data generated by magnetic resonance (MR), computer tomography (CT) or other types of scanners. Laser imagers typically include a film supply system, a film exposure system (e.g., a laser scanner), a film processing system (e.g., a thermal processor), and a transport system that moves film from the supply system along a transport path through the laser imager.

Laser imagers have typically separated the exposure and processing functions so that the exposure of film is completed prior to the film being processed or developed. However, to increase film throughput (i.e., the amount of film processed in a given time), some imagers are configured to begin processing the film while it is still being exposed. When “processing while imaging”, it is critical to isolate the film in the exposure area from downstream disturbances, such as in the processing system, for example, and to account for speed variations that may exist between the exposure and processing systems.

One type of imaging system operates the exposure unit at a rate which is greater than or equal to the rate of the downstream processing system and employs a curved guide plate in the exposure system to bend the film so that disturbances caused by vibrations or the speed differential are absorbed by movement of the film in a thickness direction of the film. The system also employs a pair of opposing stationary guide plates to guide the film from the exposure system to the processing system, one of which is curved to enable the accumulation of film slack causes by the processing system operating at slower rate than the exposure system. While such a system enables “processing while imaging,” the system requires that the operating rate of the processing system not exceed that of the exposure system and the imaging bearing surface of the film may be scratched through contact with the stationary guide plates.

While such systems may have achieved certain degrees of success in their particular applications, there is a need to provide an improved system and method for operating and transferring film from the exposure unit to the processor unit in a “processing-while-imaging” type imaging apparatus.

### SUMMARY OF THE INVENTION

An object of the present invention is to prevent disturbances encountered by an imaging media in a processing system from propagating through the imaging media to an exposure system in a processing-while-imaging type imaging apparatus.

Another object of the present invention is to enable a processing system to operate at a rate that is greater than an operating rate of an exposure system in a processing-while-imaging type imaging apparatus.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided an imaging apparatus including an exposure system having an output engagement point and operating at a first rate, and a processor having an input engagement point and operating at a second rate that is at least equal to the first rate. A guide assembly includes an entrance guide which is configured to be at an extended position and to introduce a curve to and to direct an imaging media along a curved first transport path having a first length between the output and input engagement points before a leading edge of the imaging media is engaged by the input engagement point, the first length being less than a transport direction length of the imaging media, and which is configured to move to a retracted position after the leading edge is engaged by the input engagement point but while a trailing length of the imaging media is still engaged by the output engagement point to enable the imaging media to transition to a second transport path having a second length which is less than the first length.

According to an aspect of the invention, the guide assembly includes a diverter guide, wherein the entrance guide includes a major surface configured to contact the leading edge at a desired angle of incidence when in the extended position and to curve and direct the imaging media away from an initial plane of travel in a first direction to the diverter guide.

According to an aspect of the invention, the diverter guide includes a major surface configured to contact the leading edge of the imaging media travels from the entrance guide and to curve and direct the imaging media in a direction toward the initial plane of travel and to the processor.

According to an aspect of the invention, the processor includes a rotating heated drum, wherein the diverter guide is configured to direct the imaging media to the processor at a desired angle of incidence to the drum, wherein the desired angle of incidence is measured relative to a line tangent to the drum at an initial point of contact of the leading edge with a the drum.

According to an aspect of the invention, a difference in length between the first curved transport path and the second transport path is defined as the slack length and enables the processor to operate at a second rate which is faster than the first rate at which the exposure system operates. In one embodiment, the processor is able to operate at up to a first rate which is substantially equal to the first rate multiplied by the sum of the slack length plus a length of the imaging media still engaged by the exposure unit when the leading edge is engaged by the input engagement point divided by the slack length.

By directing the imaging media along the curved first transport path, a guide assembly in accordance with the present invention causes the imaging media to contact the input engagement point of the processing system such that any impact forces are out-of-plane with a trailing portion of the imaging media still being exposed by the exposure system, thereby reducing the potential for these impact forces to create artifact-causing disturbances (e.g. velocity variations) within the exposure system. Additionally, by curving and introducing a slack length into the imaging media, a guide assembly according to embodiments of the present invention causes the imaging media to act in a spring-like fashion and absorb such impact forces, thereby further reducing the possibility of disturbances being transferred through the imaging media to the exposure system. By creating the slack length in the imaging media, a guide assembly according to embodiments of the present invention enables a transport path between the exposure system and the processing system to have a length less than a transport direction length of the imaging media and enables the processing system to operate at a rate which is faster than an operating rate of the exposure system, thereby reducing time to first print and increasing throughput of the imaging apparatus.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 shows a block illustrating generally an imaging apparatus employing an idler wheel assembly according to embodiments of the present invention.

FIG. 2 shows a diagrammatic view illustrating one embodiment of an idler wheel assembly according to the present invention.

FIG. 3 shows a schematic diagram illustrating a guide assembly according to embodiments of the present invention.

FIGS. 4A-4G show schematic diagrams illustrating the operation of the guide assembly of FIG. 3.

FIG. 5 shows a schematic diagram illustrating a guide assembly according to embodiments of the present invention.

FIGS. 6A-6C show schematic diagrams illustrating the operation of the guide assembly of FIG. 5.

FIG. 7 shows a schematic diagram illustrating a guide assembly according to embodiments of the present invention.

FIGS. 8A-8D show schematic diagrams illustrating the operation of the guide assembly of FIG. 7.

FIG. 9 shows a schematic diagram illustrating a guide assembly according to embodiments of the present invention.

FIGS. 10A-10C show schematic diagrams illustrating the operation of the guide assembly of FIG. 7.

### DETAILED DESCRIPTION OF THE INVENTION

The following is a detailed description of the preferred embodiments of the invention, reference being made to drawings in which the same reference numerals identify the same elements of structure in each of the several figures.

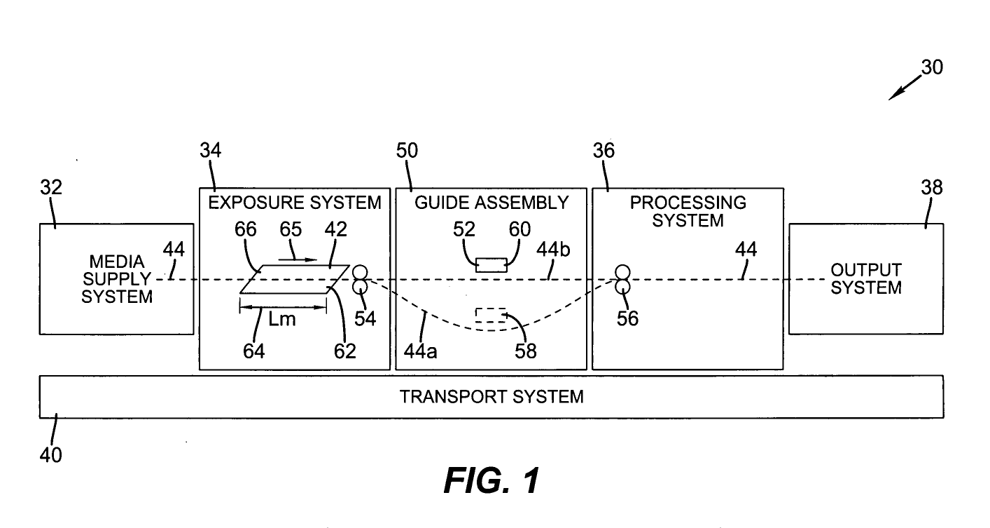

FIG. 1 is block and schematic diagram illustrating generally an example of an imaging apparatus 30, employing a moveable entrance guide according to embodiments of the present invention. Imaging apparatus 30 includes a media supply system 32, and exposure system 34, a processing system 36, an output system 38, and a transport system 40 for transporting a sheet of imaging media 42 through imaging apparatus 30 from media supply system 32 to output system 38 along a transport path 44. Imaging apparatus 30 further includes a guide assembly 50 employing a moveable entrance guide 52, according to embodiments of the present invention, for guiding imaging media 42 from exposure system 34 to processing system 36.

In operation, media supply system 32 provides an unexposed film, such as imaging media 42, to exposure system 34 along transport path 44, which begins exposing a desired photographic image on the film based on image data (e.g. digital or analog) to form a latent image of the desired photographic image on the film. In one embodiment, exposure system comprises a laser imager. Processing system 36 receives and develops the exposed imaging media. In one embodiment, processing system 36 comprises a thermal processor, such as a drum-type processor, which heats the exposed imaging media to thermally develop the latent image. Processing system 36 subsequently cools and delivers the developed imaging media along transport path 44 to output system 38 (e.g. an output tray) for access by a user.

Entrance guide 52 is configured to guide imaging media 42 from an output engagement point 54 (e.g., a nip formed by a roller pair) of exposure system 34 to an input engagement point 56 (e.g., a nip formed by a pressure roller and a processing drum) of processing system 36. In one embodiment, guide assembly is configured to direct imaging media 42 to processing system 36 so that processing system 36 may begin developing a leading portion of imaging media 42 while a trailing portion of imaging media 42 is still be exposed by exposure system 34. As such, imaging apparatus 30 is sometimes referred to as a “processing while imaging” system. In one embodiment, processing system 36 processes and transports imaging media 42 at a rate, r1, which is substantially equal to a rate, r2, at which exposure system 34 exposes and transports imaging media 42. In one embodiment, processing system 36 processes and transports imaging media 42 at rate, r1, which is greater than rate, r2, at which exposure system 34 exposes and transports imaging media 42.

In one embodiment, entrance guide 52 is moveable between an extended position 58, illustrated by the dashed lines, and a retracted position 60. In one embodiment, entrance guide 52 is configured to be in extended position 58 and configured to direct imaging media 42 between output and input engagement points 54, 56 along a curved first transport path 44a before a leading edge 62 of imaging media 42 is engaged by input engagement point 56 of processing system 36, wherein a length, La, of first transport path 44a is less than a length, Lm, 64 of imaging media 42 in a direction of transport along transport path 44, as indicated by directional arrow 65.

After leading edge 62 is engaged by input engagement point 56 of processing system 36, but while a trailing portion of imaging media 42 is still engaged by output engagement point 54 of exposure system 34, entrance guide 52 is configured to move to retracted position 60 to enable imaging media 42 to transition from following first curved transport path 44a to following a second transport path 44b, where a length. Lb, of second transport path 44b is less than the length, La, of first transport path 44a. A difference in path length between first transport path 44a and second transport path 44b is referred to herein as the “slack length,” Ls, of imaging media 42 (i.e. Ls=La−Lb).

In one embodiment, where the rate r1 of processing system 36 is greater than the rate r1 of exposure system 34, the slack length, Ls, of imaging media 42 is gradually “reeled in” by processing system 36 while the trailing portion of imaging media 42 is still engaged by exposure system 34, causing imaging media 42 to transition from first transport path 44a toward following second transport path 44b. In one embodiment, the length La of first curved path 44a is configured in conjunction with length Lm of imaging media 42, length Lb of second transport path 44b, and processing and exposure system rates r1 and r2 such that after leading edge 62 of imaging media 42 is engaged by processing system 36, a trailing edge 66 exits output engagement point 54 as imaging media 42 completes its transition from first transport path 44a to second transport path 44b.

By directing imaging media 42 along curved first transport path 44a, imaging media 42 contacts input engagement point 56 of processing system 36 such that impact forces generated when leading edge 62 contacts input engagement point 56 are out-of-plane with the trailing portion of imaging media 42 still being exposed by exposure system 34, thereby reducing the potential for these impact forces to create artifact-causing disturbances (e.g. velocity variations) in exposure system 34. Additionally, by curving and introducing a slack length into imaging media 42, guide assembly 50 causes imaging media to act in a spring-like fashion and absorb such impact forces, thereby further reducing the possibility of any disturbances being transferred through imaging media 42 to exposure system 34. As such, the transfer of any disturbances to the trailing portion of imaging media 42 still engaged by an being exposed by exposure system 34 is substantially eliminated, thereby substantially eliminating imaging artifacts associated with such disturbances.

Additionally, as will be described in greater detail below, guide assembly 50 is configured to direct leading edge 62 of imaging media 42 into processing system 36 in a fashion to substantially minimize impact with guide assembly 50 components and with input engagement point 56, thereby further reducing the potential of disturbances being transferred to the trailing portion of imaging media 42 still engaged by an being exposed by exposure system 34. Furthermore, by creating slack length, Ls, in imaging media 42, guide assembly 50 enables transport path 44 between exposure system 34 and processing system 36 to have a length less than length, Lm, of imaging media while enabling processing system 36 to operate at a rate, r1, which is faster than an operating rate, r2, of exposure system 34, thereby reducing time to first print and increasing throughput of imaging apparatus 30.

In one embodiment, by creating a slack length, Ls, in imaging media 42, the operating rate, r1, of processing system 36 relative to the operating rate, r2, of exposure system 34 can be expressed by the following Equation I:

r1=r2*[(Le+Ls)/Le] Equation I:

where:
r1=rate of processing system 36;
r2=rate of exposure system 34;
Ls=slack length (i.e. Ls=La−Lb); and
Le=length of imaging media 42 engaged by exposure system 34 after engagement by processing system 36 (i.e. Le=Lm−La).

Based on Equation I, the percent that operating rate, r1, of processing system 36 can be increased relative to operating rate, r2, of exposure system 34 can be expressed by the following Equation II:

% increase=(Ls/Le)*100=[(La−Lb)/(Lm−La)]*100 Equation II:

where:
La=length of initial curved transport path 44a;
Lb=length of second transport path 44b;
Ls=slack length (i.e. Ls=La−Lb); and
Le=length of imaging media 42 engaged by exposure system 34 after engagement by processing system 36 (i.e. Le=Lm−La).

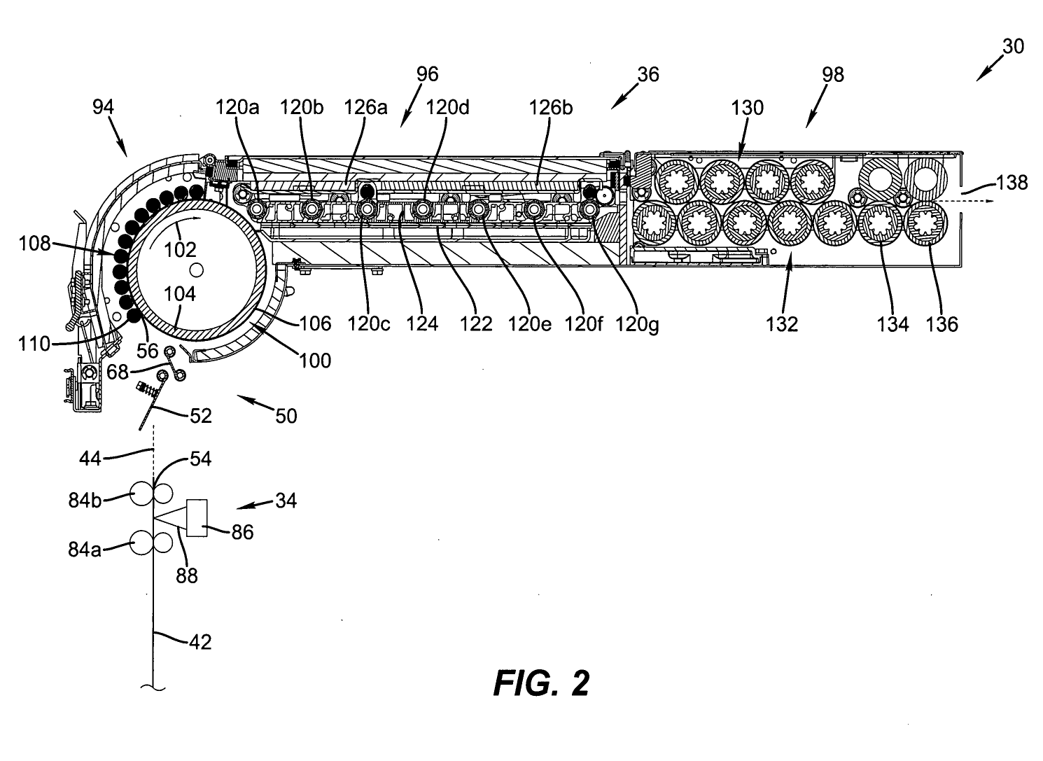

An illustrative example of operating rates r1 and r2 of processing system 36 and exposure system 34 and lengths La, Lb, and Lm of first transport path 44a, second transport path 44b, and imaging media 42 is provided below with regard to FIGS. 2 through 4G.

Similarly, where operating rate r1 of processing system 36 is greater than or equal to operating rate r1 of exposure system 34, the required slack length Ls can be expressed by the following Equation III:

Ls=Le*[(r1−r2)/r2] Equation III:

where:
Ls=slack length (i.e. Ls=La−Lb); and
Le=length of imaging media 42 engaged by exposure system 34 after engagement by processing system 36 (i.e. Le=Lm−La).

FIG. 2 is a block and schematic diagram illustrating portions of an example implementation of imaging apparatus 30 including exposure system 34, processing system 36, and employing one embodiment of guide assembly 50 according to the present invention. As illustrated by the embodiment of FIG. 2, guide assembly 50 includes entrance guide 52 and a diverter guide 68.

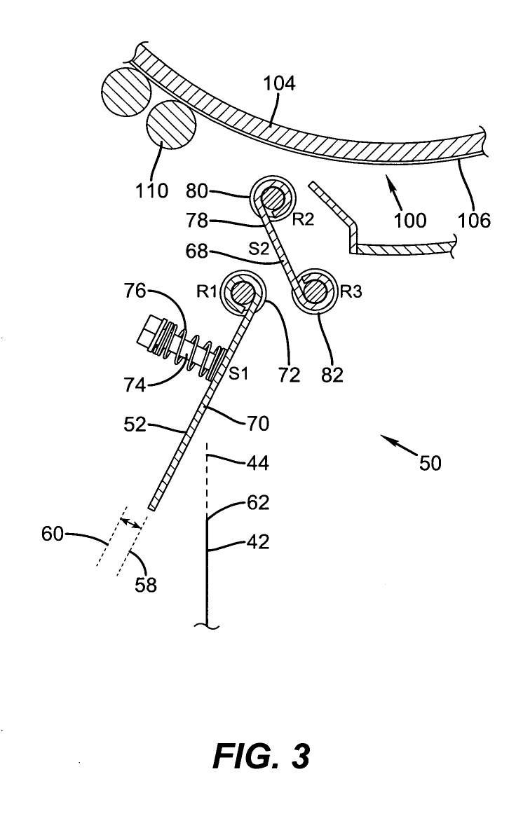

FIG. 3 is an enlarged view of portions imaging apparatus 30 of FIG. 3 and illustrates guide assembly 50 in greater detail. Entrance guide 52 includes a major surface (S1) 70 and an idler roller (R1) 72 positioned proximate to a downstream edge of entrance guide 52 relative to exposure system 34 and having a surface which extends above major surface 70. In one embodiment, major surface S1 70 comprises a polished surface so as to reduce friction when in contact with leading edge 62 of imaging media 42. Entrance guide 52 is slidably positioned on a plurality of shafts, such as shaft 74, and is configured to move along shaft 74 between extended position 58 and retracted position 60 (indicated by dashed lines). A plurality of compression springs are retained on the shafts, such as compression spring 76 on shaft 74, and configured to bias entrance guide 52 so as to normally be at extended position 58.

Diverter guide 68, unlike entrance guide 52, is stationary and includes a major surface (S2) 78, a first idler roller (R2) 80, and a second idler roller (R3) 82. As with major surface S1 70, major surface S2 78 comprises a polished surface so as to reduce friction when in contact with imaging media 42. Similar to that of idler roller R1 72, the surfaces of idler rollers R2 80 and R3 82 extend above major surface S2 78. In one embodiment, idler rollers R1 72, R2 80, and R3 82 comprise low-inertia rollers. Additionally, although not illustrated, major surfaces S1 70 and S2 78 and idler rollers R1 72, R2 80, and R3 82 extend at least across a width of transport path 44.

Returning to FIG. 2, exposure system 34 includes two sets of driven roller pairs, illustrated as 84a and 84b, each forming a nip and transporting imaging media 42 past a laser scanning unit 86, with roller pair 84b forming output engagement point 54 of exposure system 34 (see FIG. 1). As imaging media 42 moves along transport path 44, laser scanning unit 86 modulates laser light 88 based on image data to expose and form a latent image of a desired photographic image on imaging media 42.

Processing system 36 includes a drum-type processor 94, a flatbed type processor 96, and a cooling section 98. In one embodiment, drum-type processor 94 is configured to heat exposed imaging media 42 from an ambient temperature to a desired pre-dwell temperature, at which point it is transferred to flatbed type processor 96. In one embodiment, the desired pre-dwell temperature is substantially equal to a development temperature associated with imaging media 42. Flatbed type processor 96 maintains imaging media 42 at the development temperature for a desired development time, or dwell time, after which it is transferred to and cooled to an output temperature by cooling section 98.

In one embodiment, drum-type processor 94 includes a processor drum 100 that is driven so as to rotate in a direction as indicated by directional arrow 102. A circumferential heater 104 (e.g., an electric blanket heater) is mounted within an interior of drum 100 and configured to heat and maintain processor drum 100 at a temperature necessary to heat imaging media 42 to the desired pre-dwell temperature. In one embodiment, processor drum 100 is coated with a layer of silicon rubber 106. A plurality of pressure rollers 108, including a first pressure roller 110, is circumferentially arrayed along a segment of processor drum 100 and configured to hold and maintain imaging media 42 in contact with silicon rubber layer 106 of processor drum 100 during the development process. Together, silicon rubber layer 106 and first pressure roller form input engagement point 56 (see FIG. 1) of processing system 36.

In one embodiment, flatbed type processor 96 includes a plurality of rollers 120, illustrated as rollers 120a through 120g, positioned in a spaced fashion, with one or more of the rollers 120 being driven so as to transport imaging media 42 through flatbed type processor 96 from drum type processor 94 to cooling section 98. Flatbed type processor 96 further includes a heater 122 (e.g. a heat blanket) and a heat plate 124. One or more plates 126, illustrated as plates 126a and 126b, are spaced from and positioned substantially in parallel with heat plate 124 to form an oven through which imaging media 42 is transported by roller 120 and heated to the desired development temperature.

An example of a thermal processor combining a drum type processor and a flatbed type processor similar to that discussed above is described by U.S. patent application Ser. No. 11/029,592, entitled “Thermal Processor Employing Drum and Flatbed Technologies”, filed on Jan. 5, 2005, which is assigned to the same assignee as the present invention, and is herein incorporated by reference.

Cooling section 98 includes a plurality of upper rollers 130 and a plurality of lower rollers 132 offset from one another and two pairs of nip rollers 134 and 136. At least a portion of the upper and lower plurality of rollers 130 and 132 and one roller of each pair of nip rollers 134 and 136 are driven so as to transport imaging media 42 through cooling section 98. The upper and lower plurality of rollers 130 and 132 and the pairs of nip rollers 134 and 136 are configured to absorb and transfer heat away from imaging media 42 so as to cool imaging media 42 from the desired development temperature at which it is received from flatbed type processor 96 to a desired to a desired output temperature at an exit 138. An example cooling section similar to cooling section 98 is described by U.S. patent application Ser. No. 11/500,227, entitled “Thermal Processor With Cooling Section Having Varying Heat Transfer Characteristics”, filed on Aug. 7, 2006, which is assigned to the same assignee as the present invention, and is herein incorporated by reference.

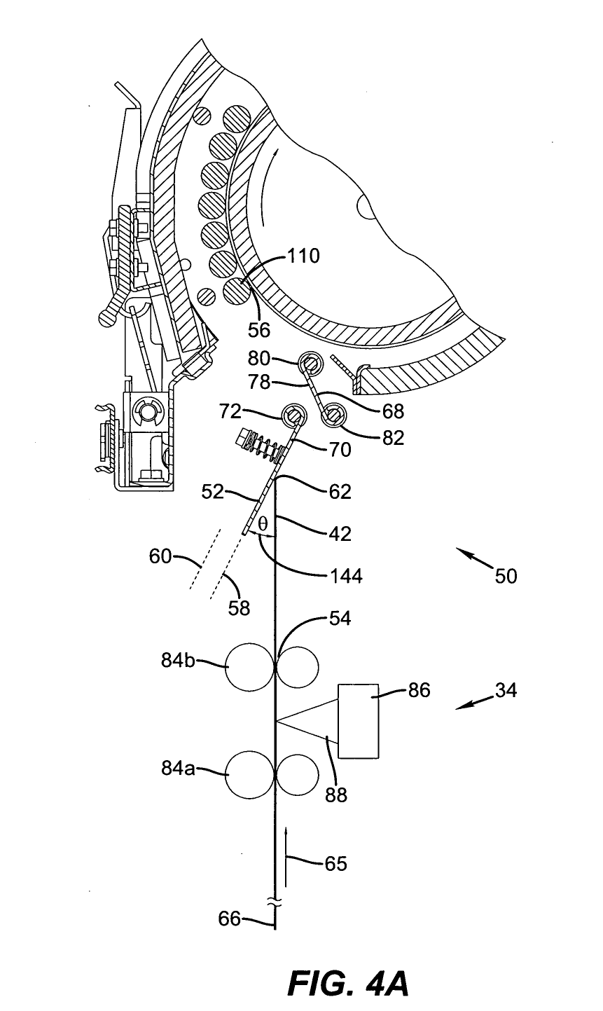

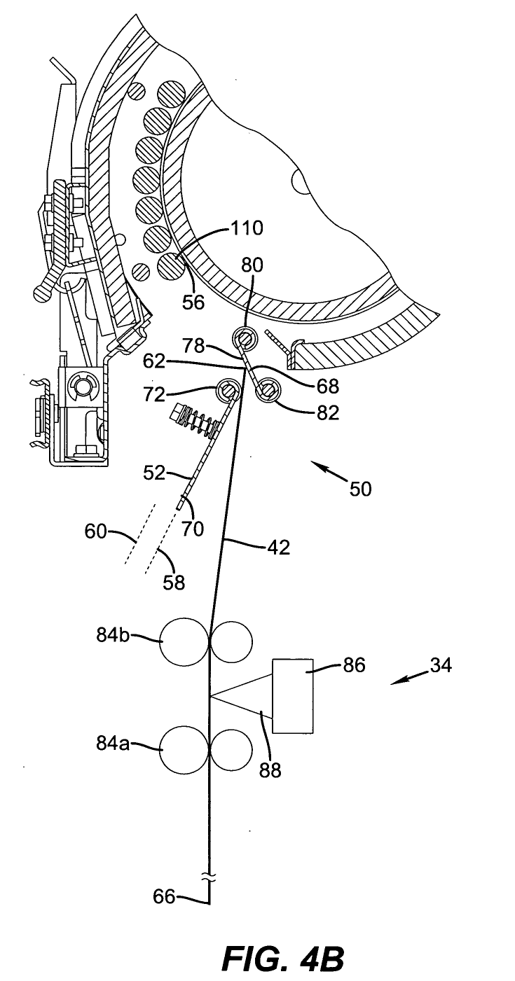

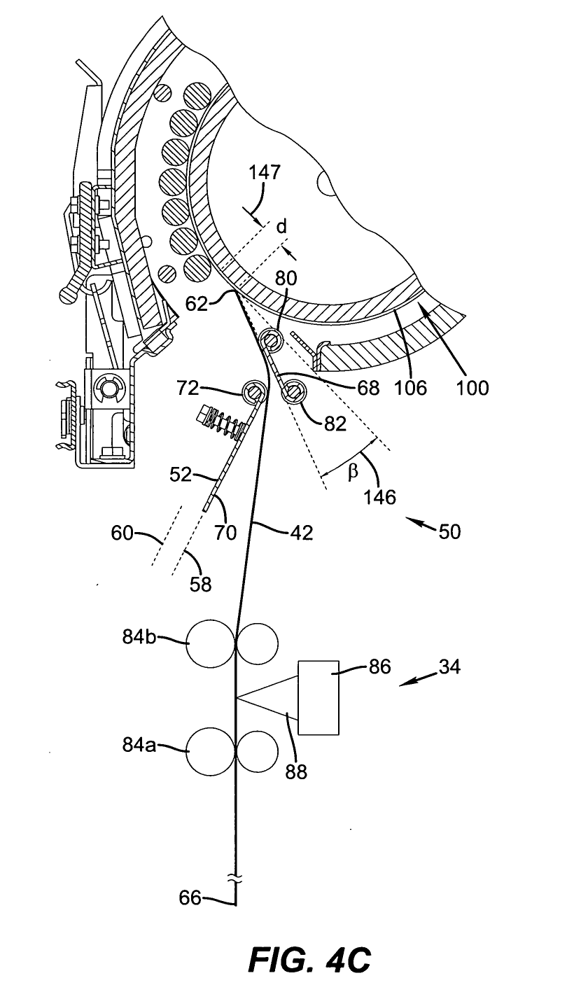

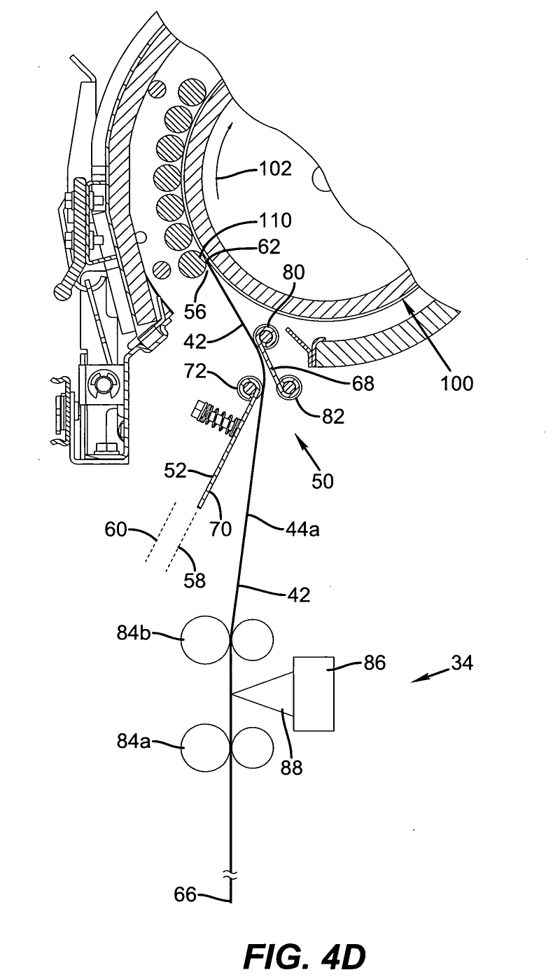

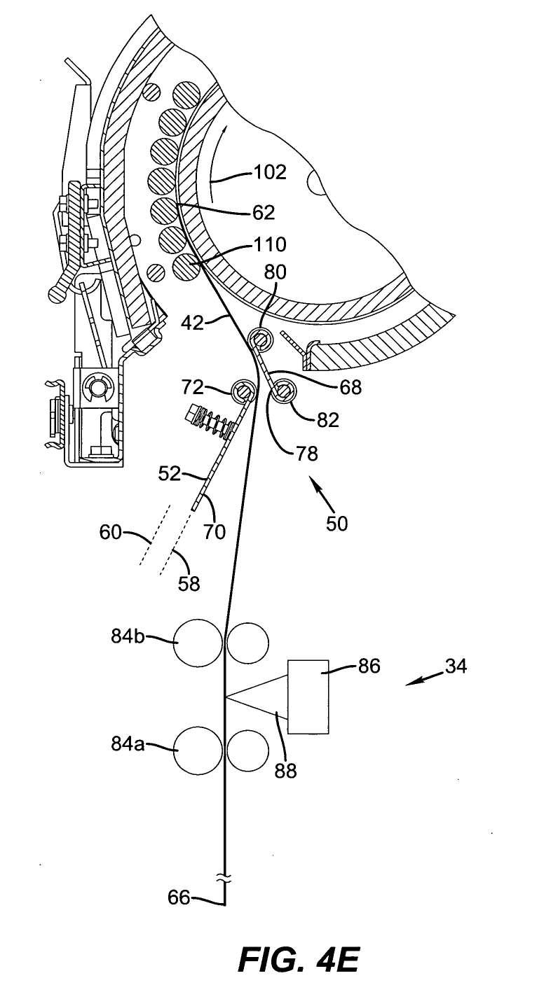

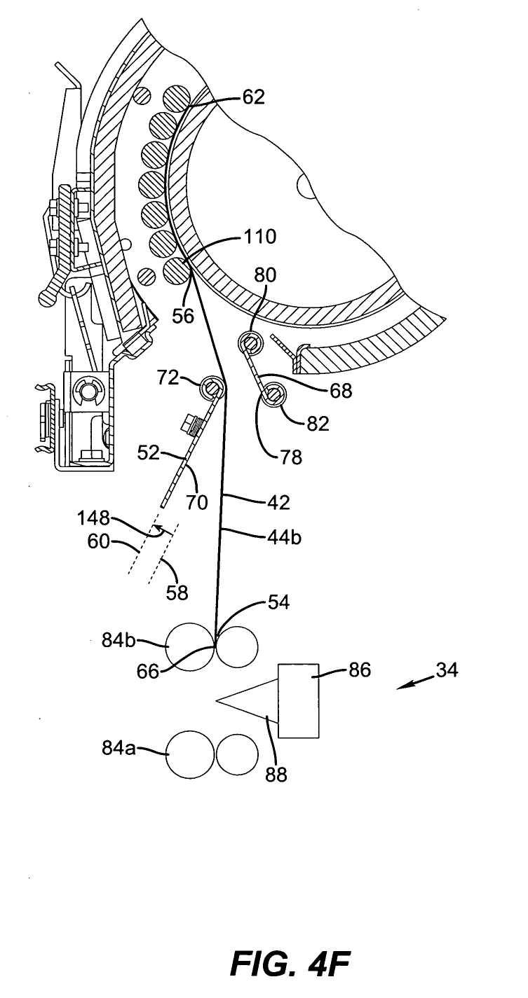

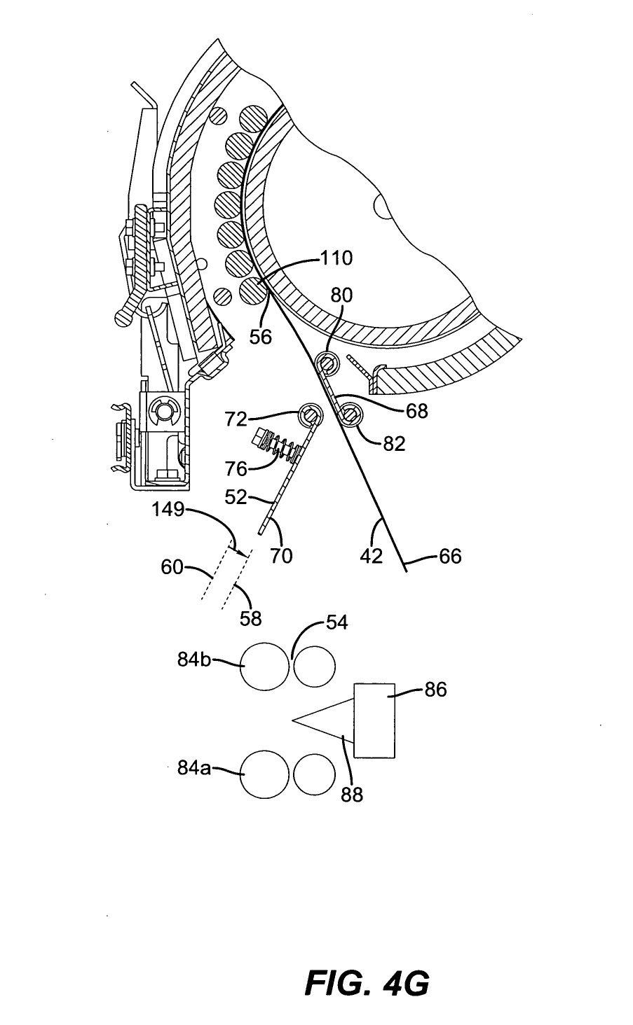

FIGS. 4A through 4E illustrate an example of the operation of guide assembly 50 illustrated above by FIGS. 2 and 3. FIG. 4A illustrates imaging media 42 as it travels from exposure system 34 to guide assembly 50, as indicated by directional arrow 65, where leading edge 62 first contacts major surface S1 70 of entrance guide 52. As roller pairs 84a and 84b of exposure system 34 continue to move imaging media 42 toward processing system 36, leading edge 62 slides along major surface S1 70 toward idler roller R1 72. Eventually, leading edge 62 rides over idler roller R1 72 and is directed toward major surface S2 78 of diverter guide 68 while a surface of imaging media 42 opposite laser scanning unit 86 rides on idler roller R1 72.

As described above, in one embodiment, major surface S1 70 comprises a polished surface to reduce friction between entrance guide 52 and leading edge 62 of imaging media 42 and to minimize the possibility of scratching or otherwise damaging the surface of imaging media 42. Additionally, entrance guide 52 is positioned such that an angle of incidence (θ) 144 with imaging media 42 is low so that leading edge 62 does not “stub” into major surface S1 70 and create a disturbance that is transferred back to the portion of imaging media 42 being scanned by laser scanning unit 86. In one embodiment, angle of incidence (θ) 144, with respect to vertical in FIG. 4A, is approximately 26.5 degrees. In one embodiment, angle of incidence (θ) 144, with respect to vertical in FIG. 4A, is within a range of approximately +/−10% of 26.5 degrees.

With reference to FIG. 4B, as roller pairs 84a and 84b of exposure system 34 continue to move imaging media 42 toward processing system 36, imaging media rides on roller R1 72 until leading edge 62 contacts major surface S2 78 of diverter guide 68. As illustrated by FIG. 4C, as imaging media 42 continues to be driven toward processing system 36, leading edge 62 slides along major surface S2 78 of diverter guide 68 and rides onto idler roller R2 80. Leading edge 62 then continues toward and contacts silicon rubber layer 106 of rotating processor drum 100 as imaging media 42 rides on the surfaces of rollers R1 72 and R2 80. By curving imaging media 42 in this fashion via entrance and diverter guides 52 and 68 of guide assembly 50, imaging media 42 acts a spring so as to absorb and prevent any shock associated with leading edge 62 contacting processor drum 100 from being transferred to the portion of imaging media 42 still being exposed by laser scanning unit 86.

As described above, in one embodiment, major surface S2 78 of diverter guide 68 comprises a polished surface to reduce friction between entrance guide 52 and leading edge 62 of imaging media 42 and to minimize the possibility of scratching or otherwise damaging the surface of imaging media 42. Additionally, diverter guide 68 is positioned to direct imaging media 42 to rotating drum 100 in a fashion such that the leading edge 62 of imaging media 42 contacts silicone layer 106 at a low angle of incidence (β) 146 and at a desired distance (d) 147 from input engagement point 56 of processor system 36. In one embodiment, the angle of incidence (β) 146 of imaging media 42 with drum 100 is approximately 11.3-degrees from tangent at the point of contact. In one embodiment, angle of incidence (β) 146 is within a range of approximately +/−5% of 11.3-degrees.

It is noted that the position of diverter guide 68 is dependent upon several factors, including the angle of incidence (θ) 144 of imaging media 42 with entrance guide 52, the desired angle of incidence (β) 146 of imaging media 42 with drum 100, and the distances between entrance guide 52, diverter guide 68, and drum 100. It is also noted that the particular values and ranges of values listed herein for the angle of incidence (θ) 144 of imaging media 42 with entrance guide 52 and the angle of incidence (β) 146 of imaging media 42 with drum 100 are associated with a particular implementation of imaging apparatus 30 and may vary depending on the parameters and dimensions (e.g. distance between exposure system 34 and processing system 36, dimensions of imaging media 42) associated with a particular implementation.

With reference to FIG. 4D, continued movement of imaging media 42 by roller pairs 84a and 84b of exposure system 34 and rotation of processor drum 100 cause leading edge 62 of imaging media 42 to be drawn into input engagement point 56 (i.e. a nip between first pressure roller 110 and silicon layer 106) of processing system 36. FIG. 4D illustrates the moment at which leading edge 62 of imaging media 42 is engaged by input engagement point 56 of processing system 36. The path followed by imaging media 42 at this moment comprises the first curved transport path 44a (see FIG. 1), at which point a maximum slack length, Ls, has been introduced to imaging media 42.

With reference to FIG. 4E, as imaging media 42 begins to wrap around processor drum 100 and is drawn further into drum-type processor 94, due to rate r1 of processing system 36 being greater than rate r1 of exposure system 34, the slack length, Ls, of imaging media 42 is gradually “reeled in” by processing drum 100 such that the transport path followed by imaging media 42 begins to transition from first curved transport 44a to second transport path 44b (see FIG. 1). As such, as illustrated by FIG. 4E, imaging media 42 is drawn away from roller R2 80 of diverter guide 68 and begins to ride only on roller R1 72 of entrance guide 52. In FIG. 4E, entrance guide 52 remains at extended position 58.

With reference to FIG. 4F, as processing system 36 continues to “reel in” slack introduced into imaging media 42 by guide assembly 50, imaging media 42 continues to ride on roller R1 72 of entrance guide 52 and begins to compress compression spring 76 and push entrance guide 52 from extended position 58 to retracted position 60, as indicated by directional arrow 148. FIG. 4F illustrates the moment at which entrance guide 52 has reached retracted position 60. The path followed by imaging media 42 at this moment comprises second transport path 44b (see FIG. 1), at which point substantially all of the slack has been removed from imaging media 42 and trailing edge 66 of imaging media 42 exits output engagement point 54 of exposure system 34.

With reference to FIG. 4G, as drum 100 continues to draw imaging media 42 into drum-type processor 94, trailing edge 66 swings free from output engagement point 54 of exposure system 34, and imaging media moves away from roller R1 72 of entrance guide 52 and rides on rollers R2 80 and R3 82 of diverter guide 68, thereby enabling compression spring 76 to return entrance guide 52 to extended position 58, as indicated by directional arrow 149. The operation described above by FIGS. 4A through 4G is repeated for each sheet of imaging media 42.

With reference to FIGS. 4A through 4G, it is noted that only the non-image bearing leading edge 62 of imaging media 42 contacts the major surfaces S1 70 and S2 78 of entrance guides 52 and 68. Otherwise, imaging media 42 rides on the rotating surfaces of low-inertia idler rollers R1 72, R2 80, and R3 82, thereby reducing the potential for artifact-causing scratching of imaging media 42.

As described above and expressed by Equations I and II above, by creating slack length, Ls, in imaging media 42, guide assembly 50 enables transport path 44 between exposure system 34 and processing system 36 to have a length less than length, Lm, of imaging media while enabling processing system 36 to operate at a rate, r1, which is faster than an operating rate, r2, of exposure system 34. In one embodiment, entrance guide 52, output engagement point 54, input engagement point 56, and diverter guide 68 are positioned such that first transport path 44a has a length, La, of approximately 4.76 inches (121 millimeters) and second transport path 44b has a length, Lb, of approximately 4.37 inches (111 millimeters), resulting in a slack length, Ls, of approximately 0.39 inches. Assuming a sheet of imaging media 42 having a length, Lm, in the direction of transport is being developed, a length, Le, of imaging media 42 still engaged by exposure system 34 when leading edge 62 is engaged by input engagement point 56 of processing system 36 is approximately 12.24 inches. In one embodiment, exposure system 34 operates at a rate of approximately 1.149 inches/second. Based on these parameters and employing Equation I above, processing system 36 may be operated at a rate, r1, of up to approximately 1.186 inches/second, an increase of approximately 3.2 percent relative to exposure system 34.

In the above example, based on the lengths La and Lb of first and second transport paths 44a and 44b and at operating rates r1 and r2 of 1.186 and 1.149 inches/second, imaging apparatus 30 is able to expose and develop imaging media 42 having lengths, Lm, of 17 inches or less (e.g. 10-inches, 12-inches, 14-inches).

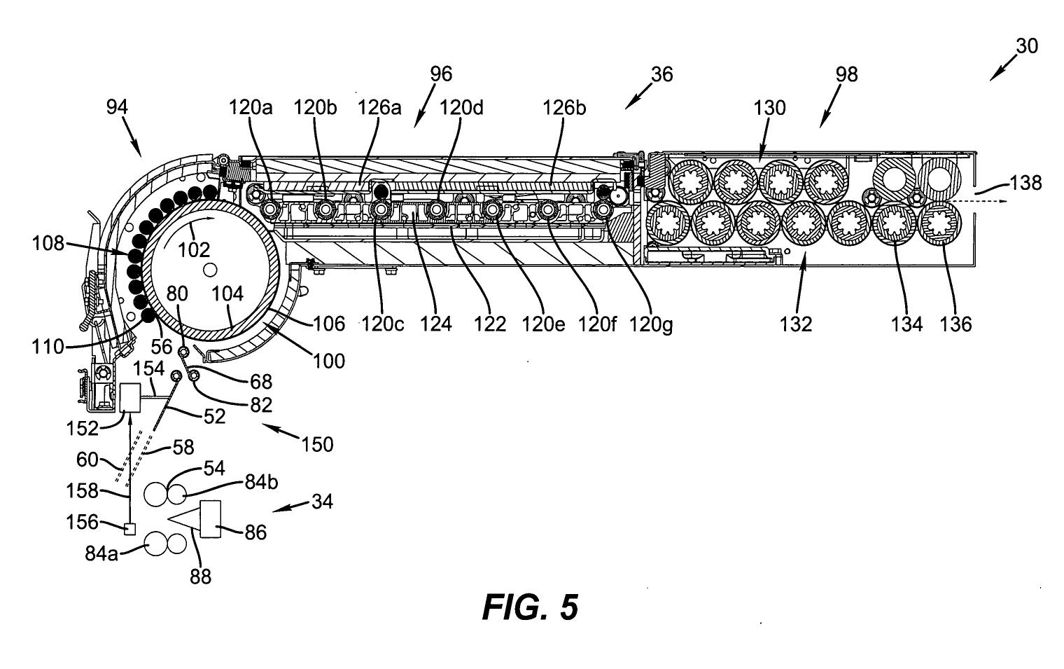

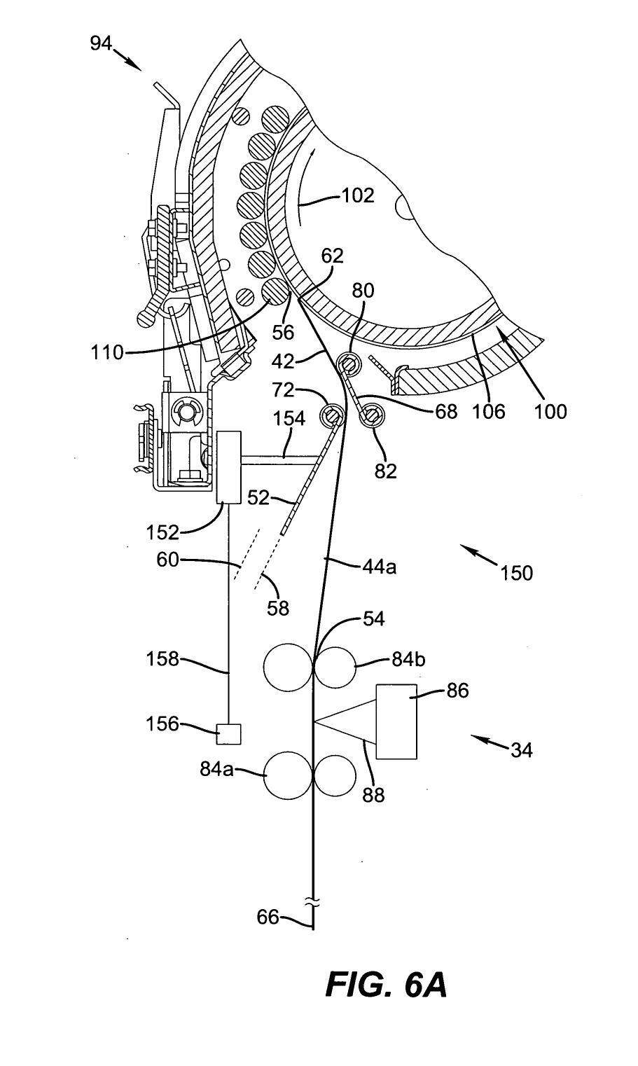

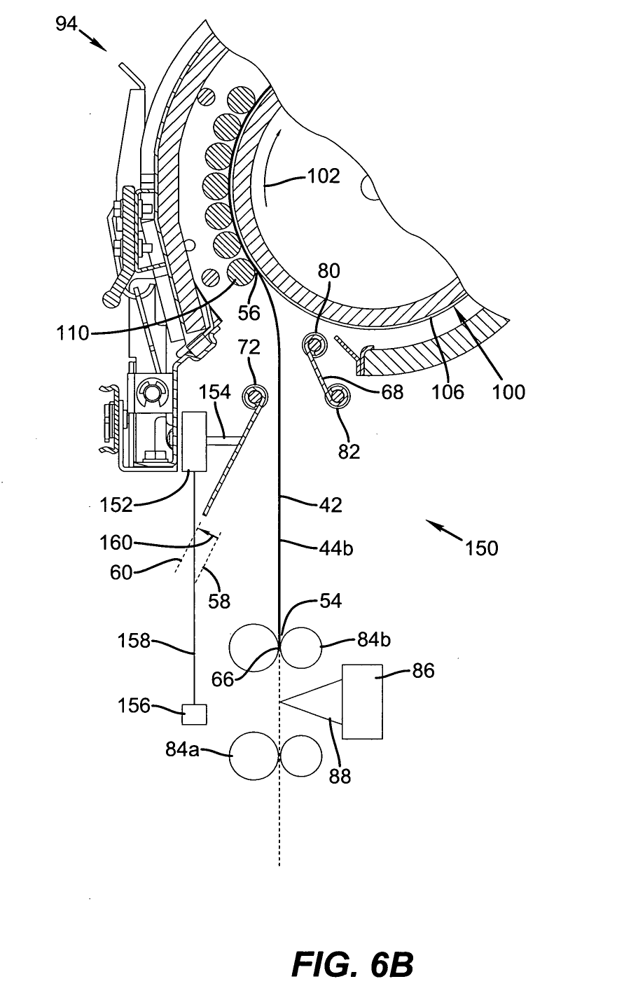

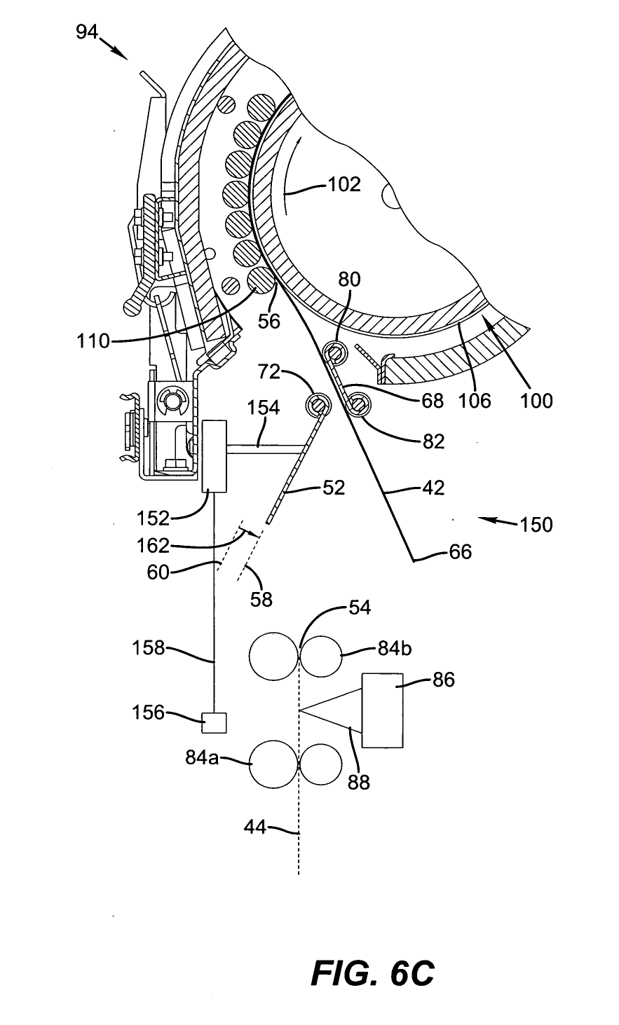

FIG. 5 illustrates one embodiment of a guide assembly 150 according to the present invention. Guide assembly 150 is similar to guide assembly 50 illustrated above by FIGS. 2 through 4G, and includes entrance guide 52 and diverter guide 68. However, unlike guide assembly 50, entrance guide 52 of guide assembly 150 is moved between extended position 58 and retracted position 60 by an actuator 152 which is coupled to entrance guide 52 by an actuator link 154. In one embodiment, guide assembly 150 includes a media sensor 156 configured to provide an indication of the presence or absence of imaging media 42 at a given location to actuator 152 via a signal path 158. In one embodiment, as illustrated by FIG. 6A, media sensor 156 comprises a portion of exposure system 34 and is configured to indicate the presence or absence of imaging media 42 within exposure system 34. In such an embodiment, based on operating rate r1 of exposure system 34 and a length of transport path 44, a position of leading edge 62 of imaging media 42 can be determined for controlling movement of entrance guide 52 by actuator 152.

FIGS. 6A through 6C illustrate the operation of guide assembly 150 of FIG. 5. As illustrated by FIG. 6A, entrance guide 52 is initially positioned at extended position 58. Initially, the operation of guide assembly 150 is similar to that of guide assembly 50 as illustrated above by FIGS. 4A through 4C. FIG. 6A illustrates the moment the moment at which leading edge 62 of imaging media 42 is engaged by input engagement point 56 of processing system 36, similar to the illustrated above by FIG. 4D with regard to guide assembly 50. The path followed by imaging media 42 at this moment comprises the first curved transport path 44a (see FIG. 1), at which point a maximum slack length, Ls, has been introduced to imaging media 42.

As illustrated by FIG. 6B, after leading edge 62 of imaging media 42 is engaged by input engagement point 56 of processing system 36 (i.e., nip formed by processor drum 100 and first pressure roller 110), actuator 152 moves entrance guide 52 from extended position 58 to retracted position 60, as indicated by directional arrow 160. As described above, actuator 152 is configured to move entrance guide 52 between extended and retracted positions 58 and 60 based on an indication received via signal path 158 from media sensor 156. In one embodiment, as leading edge 62 of imaging media 42 passes media sensor 156 in laser scanning unit 86, a signal indicating the presence of imaging media 42 is provided to actuator 152 via signal path 158. Based on operating rate r1 of exposure system 34 and length, La, of initial curved transport path 44a, actuator 152 determines when leading edge 62 of imaging media 42 will reach input engagement point 56, and thus the time to move entrance guide 52 from extended position 58 to retracted position 60.

As described above, due to rate r1 of processing system 36 being greater than rate r1 of exposure system 34, the slack length, Ls, of imaging media 42 is gradually “reeled in” by processor drum 100 such that the transport path followed by imaging media 42 begins to transition from first curved transport 44a to second transport path 44b (see FIG. 1). FIG. 6B illustrates the moment when imaging media 42 reaches second transport path 44b, at which point substantially all of the slack has been removed from imaging media 42 and trailing edge 66 of imaging media 42 exits output engagement point 54 of exposure system 34.

With reference to FIG. 6C, as processor drum 100 continues to draw imaging media 42 into drum-type processor 94, trailing edge 66 of imaging media 42 swings free from output engagement point 54 of exposure system 34 and imaging media 42 rides on rollers R2 80 and R3 82 of diverter guide 68. In one embodiment, based on a detection of trailing edge 66 of imaging media 42 by media sensor 156 and on operating rate r1 of exposure system 34, actuator 152 returns entrance guide 52 to extended position 58 after trailing edge 66 exits output engagement point 54, as indicated by directional arrow 162. The operation described above by FIGS. 6A through 6C is repeated for each sheet of imaging media 42.

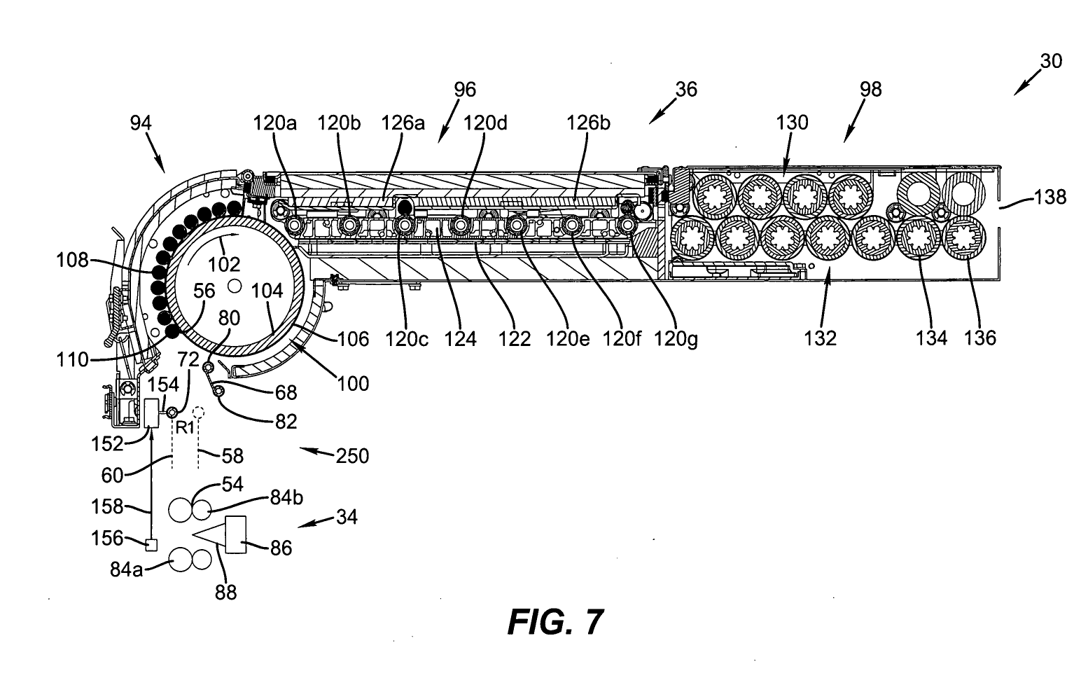

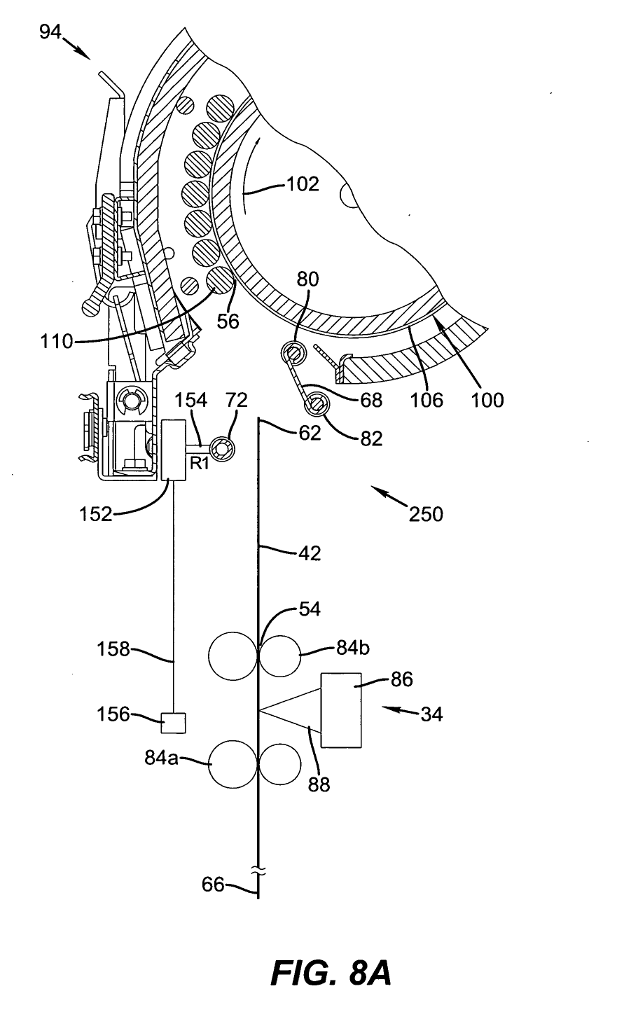

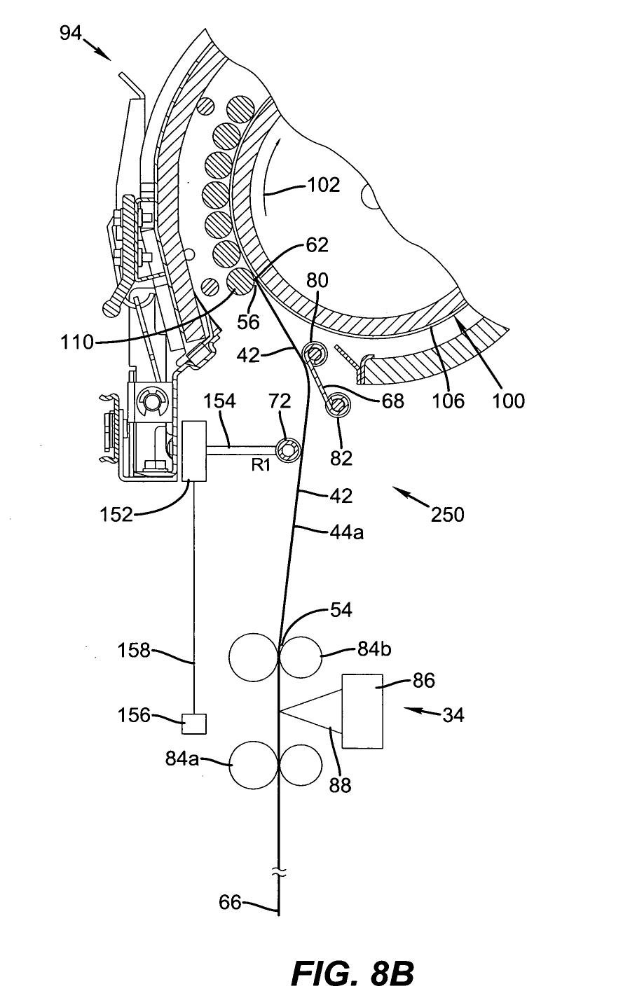

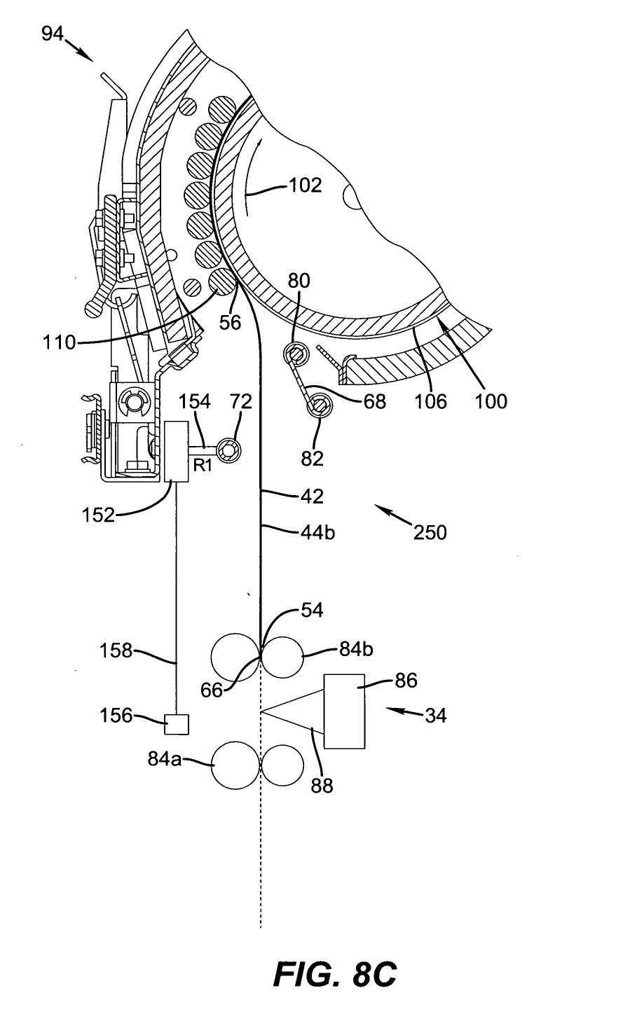

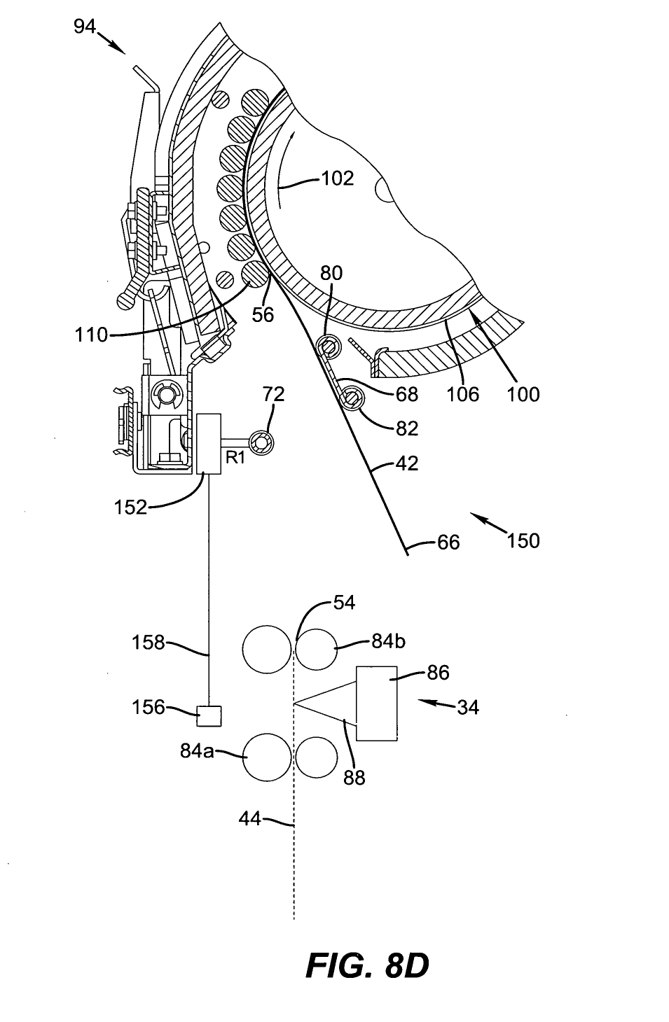

FIG. 7 illustrates one embodiment of a guide assembly 250 according to the present invention. Guide assembly 250 is similar to guide assembly 150, except that entrance guide 52 comprises only idler roller R1 72, which is moveable between extended position 58 and retracted position 60 by actuator 152. FIGS. 8A through 8D illustrate the operation of guide assembly 250 of FIG. 7.

With reference to FIG. 8A, roller R1 72 is initially positioned at retracted position 60 as imaging media 42 begins to be transported toward processing system 36 from exposure system 34. With reference to FIG. 8B, based on an indication received via signal path 158 from media sensor 156, actuator 152 moves roller R1 72 to extended position 58 after the passage of lead edge 62 so as to direct lead edge 62 to diverter guide 68. As such, unlike guide assembly 150, with guide assembly 250, imaging media 42 rides only on the surface of roller R1 72 and does not contact a surface (e.g. surface S1 70) when being directed to diverter guide 68, thereby reducing the potential of image artifacts being generated in the developed image.

Roller R1 72 remains in the extended position as diverter guide 68 directs imaging media 42 to drum-type processor 94 until leading edge 62 is engaged by input engagement point 56. FIG. 8B illustrates the moment the moment at which leading edge 62 of imaging media 42 is engaged by input engagement point 56 of processing system 36. The path followed by imaging media 42 at this moment comprises the first curved transport path 44a (see FIG. 1), at which point a maximum slack length, Ls, has been introduced to imaging media 42.

With reference to FIG. 8C, after leading edge 62 is engaged by input engagement point 56 of processing system 36 (i.e., the nip formed by drum 100 and first pressure roller 110), actuator 152 returns roller R1 72 to retracted position 60. As described above, due to rate r1 of processing system 36 being greater than rate r1 of exposure system 34, the slack length, Ls, of imaging media 42 is gradually “reeled in” by processor drum 100 such that the transport path followed by imaging media 42 begins to transition from first curved transport 44a to second transport path 44b (see FIG. 1). FIG. 8C illustrates the moment when imaging media 42 reaches second transport path 44b, at which point substantially all of the slack has been removed from imaging media 42 and trailing edge 66 of imaging media 42 exits output engagement point 54 of exposure system 34.

With reference to FIG. 8D, as drum 100 continues to draw imaging media 42 into drum-type processor 94, trailing edge 66 of imaging media 42 swings free from output engagement point 54 of exposure system 34 and imaging media 42 rides on rollers R2 80 and R3 82 of diverter guide 68. The operation described above by FIGS. 8A through 8D is repeated for each sheet of imaging media 42.

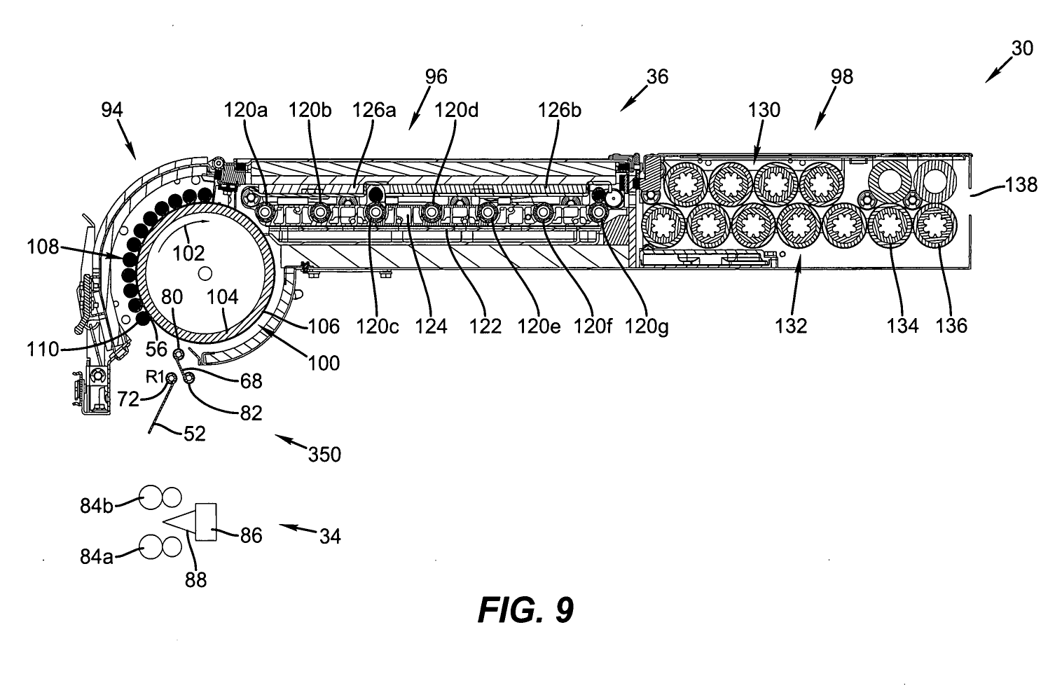

FIG. 9 illustrates one embodiment of a guide assembly 250 according to the present invention. Guide assembly is similar to guide assembly 50 illustrated above by FIGS. 2 through 4G. However, unlike guide assembly 50, entrance guide 52 of guide assembly 250 is fixed at what is extended position 58 with respect to guide assembly 50.

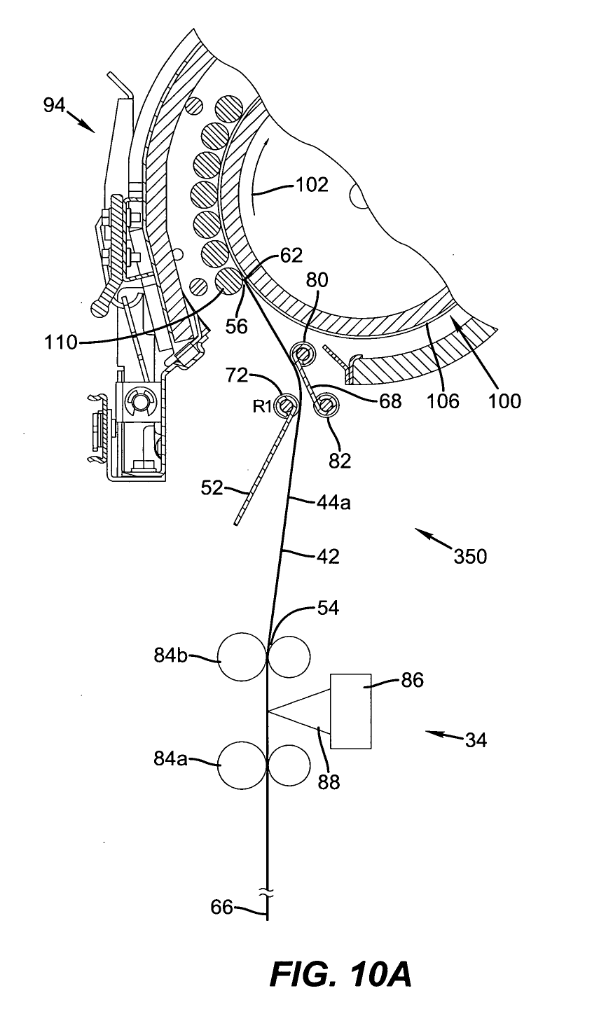

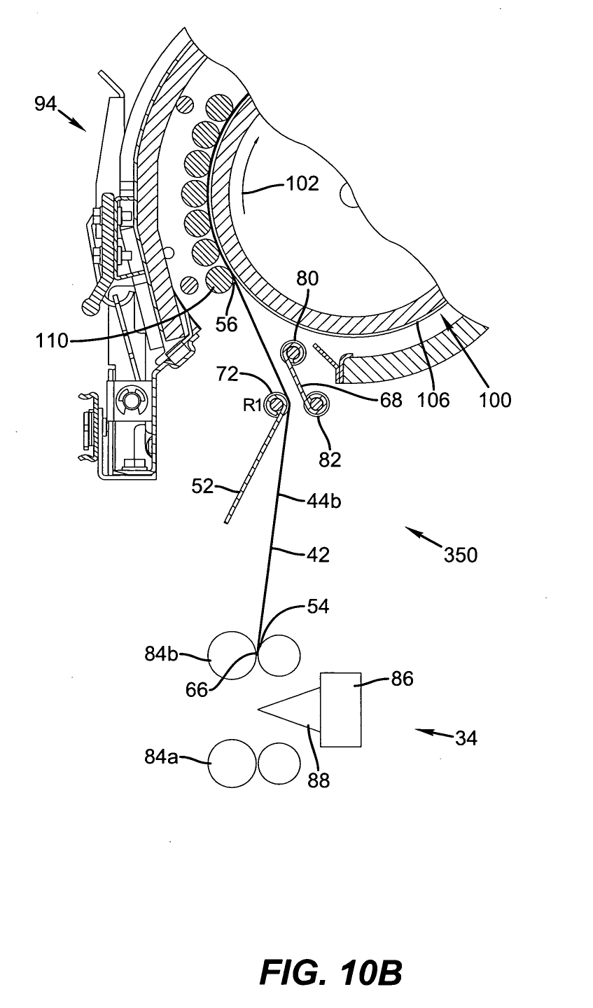

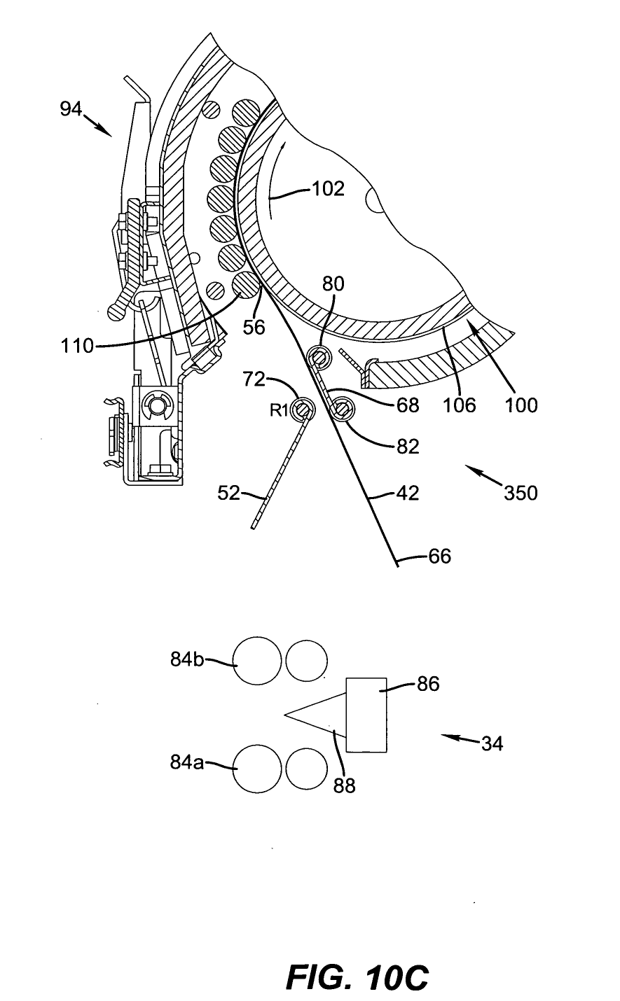

FIGS. 10A through 10C illustrate the operation of guide assembly 350 of FIG. 9. Initially, the operation of guide assembly 350 is similar to that of guide assembly 50 as illustrated above by FIGS. 4A through 4C. FIG. 10A illustrates the moment the moment at which leading edge 62 of imaging media 42 is engaged by input engagement point 56 of processing system 36, similar to the illustrated above by FIG. 4D with regard to guide assembly 50. The path followed by imaging media 42 at this moment comprises the first curved transport path 44a (see FIG. 1), at which point a maximum slack length, Ls, has been introduced to imaging media 42.

With reference to FIG. 10B, as described above, due to rate r1 of processing system 36 being greater than rate r1 of exposure system 34, the slack length, Ls, of imaging media 42 is gradually “reeled in” by processing drum 100 such that the transport path followed by imaging media 42 transitions from first curved transport 44a to second transport path 44b (see FIG. 1). FIG. 10B illustrates the moment when imaging media 42 reaches second transport path 44b, at which point substantially all of the slack has been removed from imaging media 42 and trailing edge 66 of imaging media 42 exits output engagement point 54 of exposure system 34. The transport path of imaging media 42 illustrated by FIG. 10B is similar to the position illustrated above by FIG. 4E with respect to guide assembly 50, but since entrance guide 52 of guide assembly 350 is stationary, the transport path of imaging media 42 illustrate by FIG. 10B represents second transport path 44b, whereas the transport path of imaging media 42 illustrated by FIG. 4E represents only a transition path as imaging media 42 transitions from first curved transport path 44a (see FIG. 4D) to second transition path 44b (see FIG. 4F).

With reference to FIG. 10C, as drum 100 continues to draw imaging media 42 into drum-type processor 94, trailing edge 66 of imaging media 42 swings free from output engagement point 54 of exposure system 34 and imaging media 42 rides on rollers R2 80 and R3 82 of diverter guide 68. The operation described above by FIGS. 10A through 10C is repeated for each subsequent sheet of imaging media 42.

By forming a curved transport path for imaging media 42 to follow as it is transferred from exposure system 34 to processing system 36, each of the above described guide assemblies 50, 150, 250, and 350 introduces a slack length into imaging media 42 that enables processing system 36 to operate at a faster rate than exposure system 34. Guide assemblies 150 and 250 introduce the largest amount of slack into imaging media 42 while guide assembly 350 introduces the least, meaning that guide assemblies 150 and 250 enable processing system 36 to operate at a faster rate relative to exposure system 34 than that enabled by guide assembly 350. For example, in one embodiment, based on the parameters described above with regard to FIGS. 4A through 4G, while guide assembly 50 enables processing system 36 to operate at up to 3.2% faster than exposure system 34, guide assembly 350 enables processing system 36 to operate up to only 1.0% faster than exposure system 34.

While guide assembly 50 introduces nearly as much slack into imaging media 42 as guide assemblies 150 and 250, guide assemblies 150 and 250 actively move entrance guide 52 to the retracted position so that it does not contact imaging media 42 as the slack is reeled in by processing system 36, thereby reducing the potential for scratches or other defects to be introduced into imaging media 42. However, guide assemblies 150 and 250 represent more complex implementations relative to guide assemblies 50 and 350, with guide assembly 350 being the least complex as it has no moving components.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### PARTS LIST

30 Imaging Apparatus
32 Media Supply System
34 Exposure System
36 Processing System
38 Output System
40 Transport System
42 Imaging Media
44 Transport Path
44a First Curved Transport Path
44b Second Transport Path
50 Guide Assembly
52 Entrance Guide
54 Output Engagement Point
56 Input Engagement Point
58 Extended Position
60 Retracted Position
62 Leading Edge of Imaging Media
64 Length of Imaging Media
65 Directional Arrow
66 Trailing Edge of Imaging Media
68 Diverter Guide
70 Major Surface S1 of Entrance Guide 52
72 Idler Roller R1 of Entrance Guide 52
74 Shaft
76 Compression Spring
78 Major Surface S2 of Diverter Guide 68
80 Idler Roller R2 of Diverter Guide 68
82 Idler Roller R3 of Diverter Guide 68
84a Driven Roller Pair
84b Driven Roller Pair
86 Laser Scanning Unit
88 Laser Light
94 Drum-Type Processor
96 Flatbed Type Processor
98 Cooling Section
100 Processor Drum
102 Directional Arrow
104 Circumferential Heater
106 Silicon Rubber Layer
108 Pressure Rollers
110 First Pressure Roller
120 Rollers (illustrated as 120a through 120g)
122 Heater
124 Heat Plate
126 Oven Plates (illustrated as 126a and 126b)
130 Upper Plurality of Rollers
132 Lower Plurality of Rollers
134 Pair of Nip Rollers
136 Pair of Nip Rollers
138 Exit from Cooling Section 98
144 Angle of Incidence (θ)
146 Angle (β)
147 Distance (d)
148 Directional Arrow
149 Directional Arrow
150 Guide Assembly
152 Actuator
154 Actuator Link
156 Media Sensor
158 Signal Path
160 Directional Arrow
162 Directional Arrow
250 Guide Assembly
350 Guide Assembly

What is claimed is:

1. An imaging apparatus comprising:
an exposure system having an output engagement point and operating at a first rate;
a processor having an input engagement point and operating at a second rate which is at least equal to the first rate, and
a guide assembly having an entrance guide configured to be at an extended position and to introduce a curve to and to direct an imaging media along a curved first transport path having a first length between the output and input engagement points before a leading edge of the imaging media is engaged by the input engagement point, the first length being less than a transport direction length of the imaging media, and configured to move to a retracted position after the leading edge is engaged by the input engagement point but while a trailing length of the imaging media is still engaged by the output engagement point to enable the imaging media to transition to a second transport path having a second length which is less than the first length.

2. The imaging apparatus of claim 1, wherein the guide assembly includes a diverter guide, and wherein the entrance guide includes a major surface configured to contact the leading edge at a desired angle of incidence when in the extended position and to curve and direct the imaging media away from an initial plane of travel in a first direction to the diverter guide.

3. The imaging apparatus of claim 2, wherein the desired angle is within a desired range of incident angles.

4. The imaging apparatus of claim 3, wherein the desired range of incident angles is substantially within a ten percent range of 26.5-degrees.

5. The imaging apparatus of claim 2, wherein the entrance guide includes an idler roller positioned proximate to an edge of the major surface which is downstream of a direction of travel of the imaging media, wherein a surface of the idler roller extends beyond the major surface, and wherein the leading edge of the imaging is configured to slide across the major surface and over the idler roller so that the imaging media rolls on the idler roller so as to not substantially contact the major surface as the imaging media is directed to the diverter guide.

6. The imaging apparatus of claim 2, wherein the diverter guide includes a major surface configured to contact the leading edge of the imaging media travels from the entrance guide and to curve and direct the imaging media in a direction toward the initial plane of travel and to the processor.

7. The imaging apparatus of claim 6, wherein the processor includes a rotating heated drum, and wherein the diverter guide is configured to direct the imaging media to the processor at a desired angle of incidence to the drum, wherein the desired angle of incidence is measured relative to a line tangent to the drum at an initial point of contact of the leading edge with a the drum.

8. The imaging apparatus of claim 7, wherein the desired angle of incidence is within a desired range of incident angles.

9. The imaging apparatus of claim 8, wherein the desired range of incident angles is substantially within a five percent range of 11.3-degrees.

10. The imaging apparatus of claim 6, wherein the major surfaces of the entrance guide and the diverter guide comprise polished surfaces so as to reduce friction between the major surface and the leading edge of the imaging media.

11. The imaging apparatus of claim 6, wherein the diverter guide includes a pair of rollers, one proximate to each end of the major surface and each having a surface that extends beyond the major surface, wherein the imaging media rolls on the idler roller surfaces so as to not substantially contact the major surface after a trailing edge of the imaging media exits the output engagement point of the exposure system and while the imaging media is still engaged by the input engagement point of the processor.

12. The imaging apparatus of claim 1, including an actuator coupled to and configured to move the entrance guide between the extended position and the retracted position.

13. The imaging apparatus of claim 1, wherein the second rate is greater than the first rate, wherein the entrance guide includes at least one compression spring configured to bias the entrance guide to the extended position, and wherein the imaging media compresses the at least one compression spring to move the entrance guide to the retracted position as the imaging media transitions from the curved first transport path to the second transport path.

14. The imaging apparatus of claim 1, wherein a difference in length between the first curved transport path and the second transport path is defined as the slack length and enables the processor to operate at a second rate which is faster than the first rate at which the exposure system operates.

15. The imaging apparatus of claim 1, wherein the processor is able to operate at up to a first rate which is substantially equal to the first rate multiplied by the sum of the slack length plus a length of the imaging media still engaged by the exposure unit when the leading edge is engaged by the input engagement point divided by the slack length.

16. The imaging apparatus of claim 1, wherein the entrance guide comprises an idler roller moveable between the extended and retracted positions.

17. A method of operating an imaging apparatus including an exposure system and a thermal processor, the method comprising:
operating an exposure system at a first rate, the exposure system having an output engagement point;
operating the thermal processor at a second rate which is at least equal to the first rate, the thermal processor having an input engagement point;
positioning an entrance guide at an extended position to introduce a curve to and to direct an imaging media along a curved first transport path having a first length between the output and input engagement points before a leading edge of the imaging media is engaged by the input engagement point, the first length being less than a transport direction length of the imaging media; and
moving the entrance guide to a retracted position after the leading edge is engaged by the input engagement point but while a trailing length of the imaging media is still engaged by the output engagement point to enable the imaging media to transition to a second transport path having a second length which is less than the first length.

18. The method of claim 17, wherein directing the imaging media along the curved first transport path includes:
contacting the leading edge at a desired angle of incidence with a major surface of the entrance guide when in the extended position to curve and direct the imaging media away from an initial plane of travel in a first direction to a diverter guide; and
contacting the leading edge at a desired angle of incidence with a major surface of the diverter guide as the leading edge travels from the entrance guide so as to curve and direct the imaging media in a direction back toward the initial plane of travel and to the input engagement point of the thermal processor.

19. The method of claim 18, further including:
operating the thermal processor at a second rate which is greater than the first rate.

20. The method of claim 19, wherein moving the entrance guide to the retracted position includes moving the entrance guide with the imaging media as it transitions for the first curved transport path to the second transport path.

21. The method of claim 18, wherein moving the entrance guide includes moving the entrance guide with an actuator.

22. A laser imaging apparatus comprising:
a laser scanning unit including an output engagement point and configured to scan and transport an imaging media at a first rate;
a processor including an input engagement point and configured to thermally develop and transport the imaging media at a second rate, wherein the second rate is faster than the first rate; and
a guide assembly having an entrance guide configured to be at an extended position and to introduce a curve to and to direct an imaging media along a curved first transport path having a first length between the output and input engagement points before a leading edge of the imaging media is engaged by the input engagement point, the first length being less than a transport direction length of the imaging media, and configured to move to a retracted position after the leading edge is engaged by the input engagement point but while a trailing length of the imaging media is still engaged by the output engagement point to enable the imaging media to transition to a second transport path having a second length which is less than the first length.

23. The laser imaging apparatus of claim 22, wherein a difference in length between the first curved transport path and the second transport path is defined as the slack length, and wherein the processor is able to operate at up to a second rate which is substantially equal to the first rate multiplied by the sum of the slack length plus a length of the imaging media still engaged by the exposure unit when the leading edge is engaged by the input engagement point divided by the slack length.
